(19) United States
(12) Patent Application Publication
(10) Pub. No.: US 2008/0193128 A1
(43) Pub. Date: Aug. 14, 2008

(54) COMPUTER ETHERNET CARD BASED ON PASSIVE OPTICAL NETWORK

(76) Inventors: Baomin Hu, Wuhun (CN); Zhanbing Yang, Wuhun (CN); Wei Xu, Wuhun (CN); Zhi Zheng, Wuhun (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/830,472

(22) Filed: Jul. 30, 2007

(30) Foreign Application Priority Data
Feb. 9, 2007 (CN) 200710051520.5

(51) Int. Cl. H04B 10/20; H04J 14/00

(52) U.S. Cl. 398/58

(57) ABSTRACT

The present invention relates to a computer Ethernet card used for a passive optical fiber access network and its data transmission terminals. A hardware network system that is based on a PON system optical network unit and is coupled to a computer via PCI interfaces is disposed. The hardware network system includes an optical network unit and its peripheral circuits, an end of which is coupled to an access optical fiber via an optical fiber transceiver, and the other end of which is coupled to computer PCI interfaces via a giga-Ethernet MAC controller. The present invention provides a network card based on passive optical network, which utilizes the technology of passive optical network when accessing to an upper layer server, lengthens the access distance, and reduces the structure complexity and cost of FTTD. The present invention allows tighter combination between the computer and the optical network, not only have the features of high bandwidth and low interference, but also have the advantages of simplified system, compact structure, easy installation and maintenance, and low price.

### TECHNICAL FIELD

The present invention relates to the fields of optical fiber communication and computer network communication, more specifically, to a computer Ethernet card used for a passive optical fiber access network and its data transmission terminals.

### BACKGROUND ART

A Passive Optical Networks (PON) implements access to integrated services based on the topology of a point-to-multipoint optical network, primarily access to a plurality services by a user with a convergent network or a wide area network. Generally, the system configuration of PON is composed of an optical line terminal (OLT) and an optical network unit (ONU), and a passive optical distribution network (ODN) located between the OLT and the ONU. Existing service modes mostly provides access to a plurality of services in the optical network unit (ONU). Due to the trend of diversity and complexity of the service categories at an access side, the requirements for the optical network unit (ONU) are increasing—not only performing transmission of PON network data signals, but also performing complex service processing functions (e.g., coding and decoding of VoIP and IPTV), which directly results in increased complexity in hardware, difficulty in manufacturing, and high cost.

To this end, it is desired to provide a computer Ethernet card based on PON that can implement access to a plurality of services by utilizing powerful computing compatibility of a computer. There are a variety of modes for FTTx (fiber-to-the-where) network based on PON: FTTC, FTTB, FTTO, FTTH, FTTD. Apart from FTTD, all the other technologies are incomplete optical transmissions at the access layer that there is always a segment utilizing traditional copper cable transmission. This would not result in the features of high bandwidth and low interference of optical transmissions.

### SUMMARY OF INVENTION

The technical problem solved by the present invention is to provide an Ethernet card that directly implements Ethernet access on a computer based on the PON access technology, directed to the above deficiencies of the prior art. The Ethernet card combines the computer with the optical network more tightly, and not only have the features of high bandwidth and low interference, but also have the advantages of simplified system, compact structure, easy installation and maintenance, and low price.

The technical solution used for solving the above technical problem is as below: setting a hardware network system that is based on a PON system optical network unit and is coupled to a computer via PCI interfaces. The hardware network system includes an optical network unit and its peripheral circuits. The optical network unit and its peripheral circuits are coupled to access optical fibers via an optical fiber transceiver. The other end of the optical network unit and its peripheral circuits are coupled to the computer PCI interfaces via a giga-Ethernet MAC controller.

In the above technical solution, the optical network unit and its peripheral circuits are composed of an ONU chip and its peripheral circuits. A serial-to-parallel and parallel-to-serial module may be cascaded between the optical fiber transceiver and the optical network unit and its peripheral circuits. A PHY chip may be cascaded between the giga-Ethernet MAC controller and the optical network unit and its peripheral circuits.

In the above technical solution, the optical fiber transceiver is a bursting optical module which translates received optical signals to electrical signals to perform downlink optic-electro conversion and translates received electrical signals to optical signals to perform uplink electro-optic conversion, and transmits optical signals in bursts according to control of a protocol and data processing module. The optical network unit and its peripheral circuits mostly perform protocol and data processings associated with the passive optical network for the protocol and data processing module. The optical network unit extracts data to be transmitted to itself in a downlink direction to perform downlink data transmission, and utilizes time division or wave division in an uplink direction according to protocols associated with the PON—that is, transmitting data transmitted by respective optical network units by carrying the data on independent different slots or wavelengths and converging the data when arriving at ODN. The converged signal is transmitted to the OLT via the same optical fiber. At the same time, the optical network unit performs processings and configurations of the protocols associated with the PON. The giga-Ethernet MAC controller is a computer network device module, which receives the frames transmitted by the passive optical network protocol and data processing module in a downlink direction, re-combines the frames into data and transmits the data to the computer where it locates, and encapsulates the data of the computer into frames in an uplink direction, and transmits the data to a network via the passive optical network protocol and data processing module. The computer, after receipt of data, calls different application programs to perform the processings of a plurality of services based on the difference in services. For VoIP service, Skype or MSN Messenger may be called for processing while supporting the function of video telephones. For IPTV, software such as IPTV view (for supporting video ordering) and PPlive (Point-to-point video playing) may be called for performing IP video service. For other services required by the client for implementation on the computer, different client terminals may be installed for implementation.

The advantages achieved by the present invention includes: (1). the present invention provides a computer Ethernet card of a computer that is based on PON, integrates processing of the optical network unit of PON and data transmission of the computer into a card with PCI interfaces, and implements multi-service processings for the data network with software; the features of the present invention that differs from other existing network cards (such as wireless network card, coaxial cable network card, twisted pair wire network card) are: it is a network card based on a passive optical network, utilizes passive optical network technologies for the access to upper-layer servers, lengthens the distance for access, and reduces the structure complexity and cost of the FTTD; (2) for the existing OLT devices, the PON computer Ethernet card can be used as an ONU device; due to the powerful function of PC, the PON computer Ethernet card may be driven as an ordinary network card without other requirements for configurations; (3) the powerful computing capability of the existing computer CPU may be fully utilized to support a plurality of applications based on IP (e.g., VoIP function may be supported without IAD, IPTV function may be directly supported, etc.); the present invention combines the computer and the optical network more tightly together, and not only have the features of high bandwidth and low interference, but also have the advantages of simplified system, compact structure, easy installation and maintenance, and low price; and (4) the chip integrity of the existing client device ONU is very high, and an ONU with a single Gbe interface may be fabricated with a size of two cigarette cases so that the ONU may be easily integrated into a computer as a network card; since the existing ONU software driver already has uC and Linux versions of built-in system, the transplant of the driver on windows and linux of PC becomes easy.

Compared with traditional network cards (e.g., coaxial network card and RJ45 network card), the computer Ethernet card based on PON has the following advantages: (1) long transmission distance, the coaxial line has a longest transmission distance of 800 meters, the twisted pair line has a transmission distance of 100 meters, while the longest transmission distance allowed by the optical signals of EPON is 20 kilometers; (2) low interference, due to the inherent features of optical signals, the interference in optical fiber transmission is much lower than that resulted in by electrical signals transmitting in cables; (3) low cost, the optical fiber is cheaper in cost than the cable. Compared with wireless network card, the computer Ethernet card based on PON has features of high bandwidth and high stability. For optical network cards that also are optical access devices, the number of optical fibers may be reduced due to the point-to-multipoint feature inherent by the PON system.

With the access network development into broadband, integration, polynary and optical fiber, the final development object for wired access is to implement Fiber-To-The-Home/Office (FTTH/O) so as to provide a unified integrated service access platform. PON technology can implement integrated access for voice, data, and multimedia services. With the progress of the technology and the everlasting development of requirements, PON has become a hotspot that conventional and new telecommunication carriers are interested in. The computer network based on PON utilizes the technology and infrastructure of PON, combines more tightly with existing networks and computers, and has a promising future in market.

### DESCRIPTION OF FIGURES

FIG. 1 is a block diagram of a circuit according to a first embodiment of the present invention.

FIG. 2 is a block diagram of a circuit according to a second embodiment of the present invention.

FIG. 3 is a block diagram of a circuit according to a third embodiment of the present invention.

FIG. 4 is a block diagram of a circuit according to a fourth embodiment of the present invention.

FIG. 5 is a structure diagram of an optical network unit and its peripheral circuits.

FIG. 6 is a software diagram of a computer Ethernet card according to the present invention that is based on PON.

### DETAILED DESCRIPTION

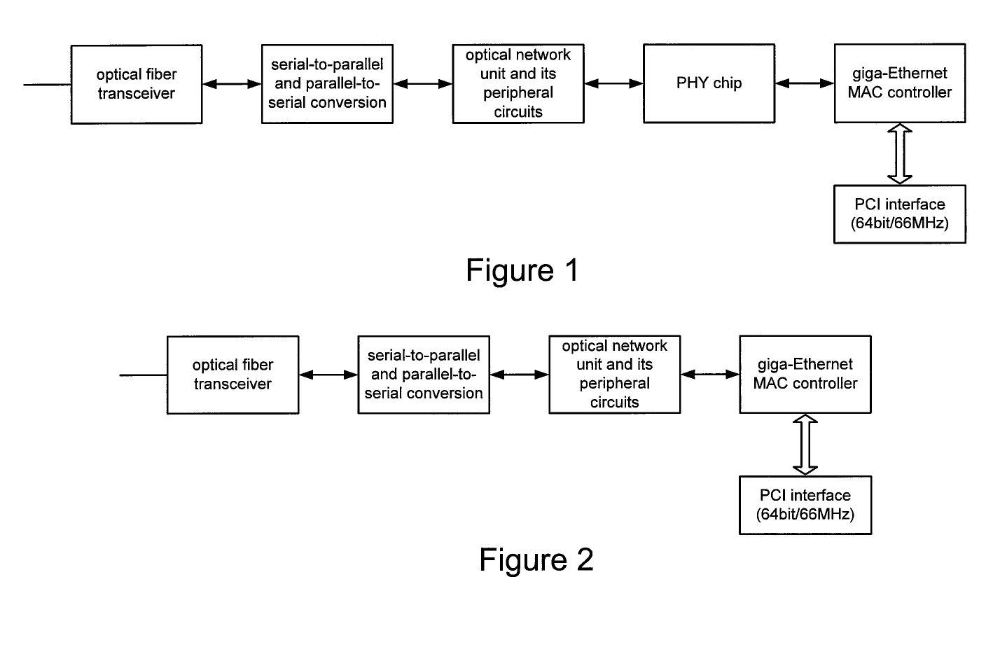

Detailed embodiments are described hereinafter in combination with figures. The first embodiment is shown in FIGS. 1, 5, and 6. A hardware network system that is based on a PON system optical network unit and is coupled to a computer via PCI interfaces is disposed.

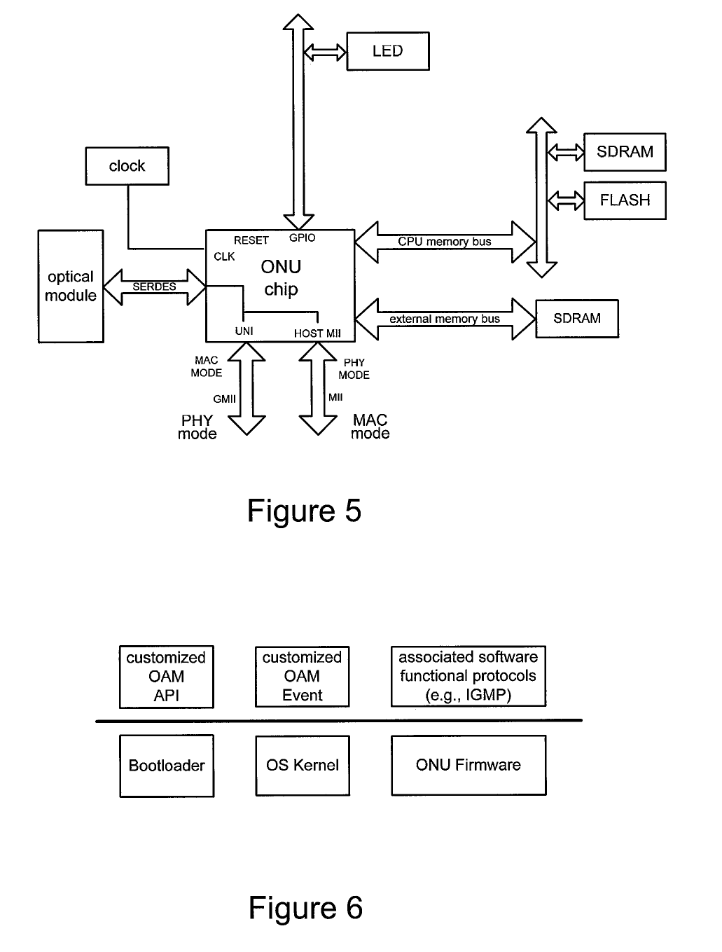

The hardware network system includes an optical network unit and its peripheral circuits. An end of the optical network unit and its peripheral circuits is coupled to an access optical fiber via a serial-to-parallel and parallel-to-serial conversion module and an optical fiber transceiver. The serial-to-parallel and parallel-to-serial conversion module performs reciprocal transformation between parallel signals and serial signals. The other end of the optical network unit and its peripheral circuits is coupled to computer PCI interfaces via a PHY chip and a giga-Ethernet MAC controller. In general, the giga-Ethernet MAC controller only provides a 10/100 Base-Tx interface or 10/100/1000 Base-Tx interface, while a client network side of the protocol and data processing module of a passive optical network only provides GMII or TBI interface but needs a PHY chip added for interconnection. As shown in FIG. 5, the optical network unit and its peripheral circuits are composed of an ONU chip and a chip with peripheral circuits. The peripheral circuits include: a clock (connecting to the CLK interface of the ONU chip), a display LED (connecting to the general-purpose input/output port of the ONU chip), fast memory SDRAM and flash memory FLASHCPU (connecting to a CPU memory bus), and external fast memory SDRAM (connecting to an external memory bus of the ONU chip). Further, the ONU chip is coupled to the optical fiber transceiver or the serial-to-parallel and parallel-to-serial conversion module via a SERDES interface. UNI and HOSTMII are two connecting interfaces of external circuit modules with two different modes. The software system of the present invention are divided into two layers and six modules. The first layer includes bootload (booting program), OS kernrl (operating system program), and fireware of ONU (program associated with PON bottom function) that performs the function of software booting and driving and provides a platform run by upper application programs. The second layer includes a customized OAM API (implementation for detailed functions), a customized OAMEvent (processing for detailed events), and associated functional protocols (communication protocol processing associated with the data network) that performs functions at the application layer.

The second embodiment is shown in FIG. 2, and its difference from the first embodiment is: when the giga-Ethernet MAC controller module provides a GMII interface, the optical network unit and its peripheral circuits (i.e., the protocol and data processing module of the passive optical network) can directly connect to the giga-Ethernet MAC controller. Other parts are the same as in the first embodiments.

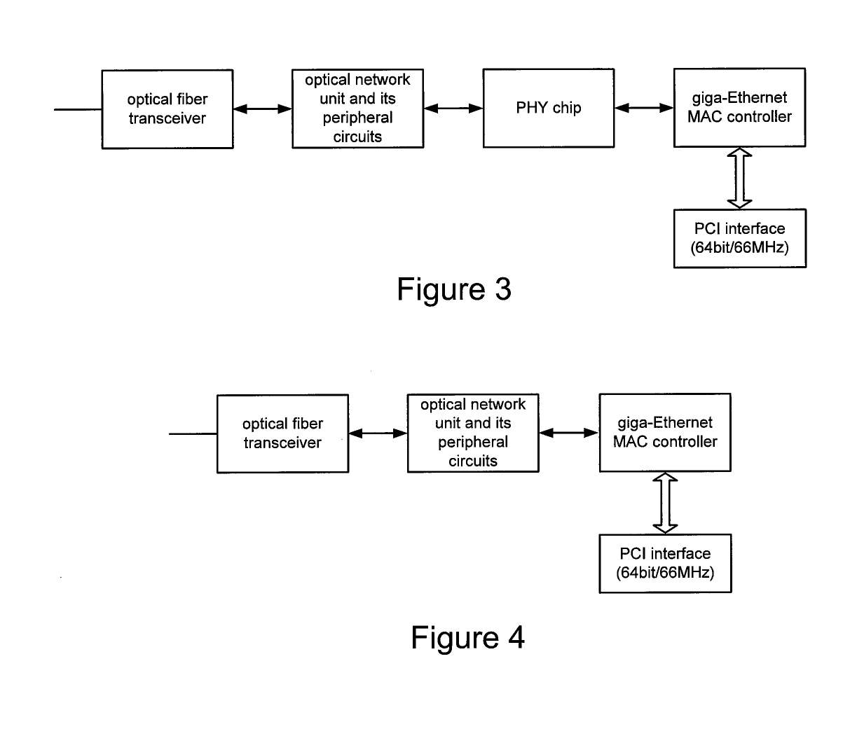

The third embodiment is shown in FIG. 3, and its difference from the first embodiment is: when the optical network unit and its peripheral circuits performs serial-to-parallel and parallel-to-serial conversions, it can directly connect to the optical fiber transceiver. Other parts are the same as in the first embodiments.

The fourth embodiment is shown in FIG. 4. When the optical network unit and its peripheral circuits performs serial-to-parallel and parallel-to-serial conversions and at the same time the giga-Ethernet MAC controller module provides a GMII interface, the external PHY chip and serial-to-parallel and parallel-to-serial conversions can be omitted, and the optical network unit and its peripheral circuits (i.e., the protocol and data processing module of the passive optical network) can directly connect to the giga-Ethernet MAC controller and the optical fiber transceiver.

1. A computer Ethernet card based on a passive optical network, wherein a hardware network system that is based on a PON system optical network unit and is coupled to a computer via PCI interfaces is disposed, the hardware network system including an optical network unit and its peripheral circuits, an end of which being coupled to an access optical fiber via an optical fiber transceiver, and the other end of which being coupled to computer PCI interfaces via a giga-Ethernet MAC controller.

2. The computer Ethernet card based on passive optical network as recited in claim 1, wherein the optical network unit and its peripheral circuits are composed of an ONU chip and its peripheral circuits.

3. The computer Ethernet card based on passive optical network as recited in claim 2, wherein a serial-to-parallel and parallel-to-serial conversion module is cascaded between the optical fiber transceiver and the optical network unit and its peripheral circuits.

4. The computer Ethernet card based on passive optical network as recited in claim 2 or 3, wherein a PHY chip is cascaded between the giga-Ethernet MAC controller and the optical network unit and its peripheral circuits.

5. The computer Ethernet card based on passive optical network as recited in claim 1, wherein the optical network unit and its peripheral circuits are composed of an ONU chip and its peripheral circuits, the peripheral circuits including a clock connecting to the CLK interface of the ONU chip, a display LED connecting to the general-purpose input/output port of the ONU chip, fast memory SDRAM and flash memory FLASHCPU connecting to a CPU memory bus, and an external fast memory SDRAM connecting to a external memory bus of the ONU chip, the ONU chip further connecting to the optical fiber transceiver or the serial-to-parallel and parallel-to-serial conversion module via a SERDES interface, the UNI and the HOSTMII being two connecting interfaces of external circuit modules with two different modes.
